(19) United States
(12) Patent Application Publication
(10) Pub. No.: US 2025/0239818 A1
(43) Pub. Date: Jul. 24, 2025

(54) Power Cable, Electrical Device and Communication System

(71) Applicant: Hilti Aktiengesellschaft, Schaan (LI)

(72) Inventor: Benjamin BÖHM, Weilheim (DE)

(21) Appl. No.: 18/702,109

(22) PCT Filed: Oct. 4, 2022
(86) PCT No.: PCT/EP2022/077554

§ 371 Date: Apr. 17, 2024

(30) Foreign Application Priority Data
Oct. 18, 2021 (EP) 21203146.2

(51) Int. Cl. H01R 13/66; H01R 24/28; H01R 31/06

(52) U.S. Cl. CPC H01R 13/6691; H01R 13/6658; H01R 24/28; H01R 31/065

(57) ABSTRACT

A power cable for an electrical device includes a plug and a functional unit. The plug includes a first group of contacts for supplying energy to the electrical device and a second group of contacts for data transfer between the power cable and the electrical device. The functional unit has a first interface for data exchange between the electrical device and the functional unit.

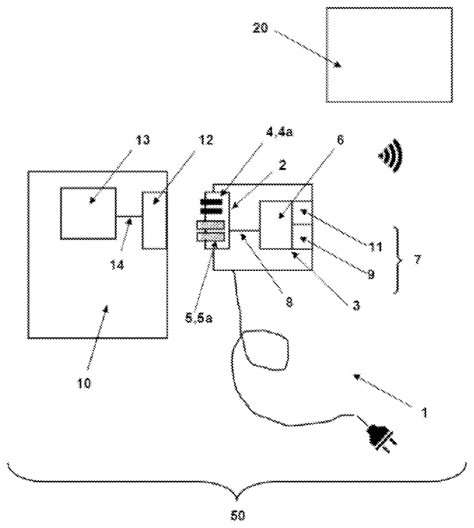

### BACKGROUND AND SUMMARY OF THE INVENTION

The invention relates to a power cable for an electrical device, which power cable has a plug and a functional unit. The plug comprises a first group of contacts for supplying energy to the electrical device, and a second group of contacts for data transfer between the power cable and the electrical device. The functional unit has a first interface for data exchange between the electrical device and the functional unit. In a second aspect, the invention relates to the electrical device, which can be connected to the proposed power cable for energy supply purposes. In a further aspect, the invention relates to a system having a power cable, an electrical device and a further electrical device, wherein a communication facility can be provided between the power cable and the further electrical device by means of a second interface of the functional unit of the power cable. The invention can advantageously facilitate communication between the power cable and a first and/or a second electrical device.

In the power-tool sector, power tools are known for which the energy supply can be ensured via a public energy network or construction-site energy network. Line-powered power tools such as these can be used flexibly and with high performance as long as a public energy network or construction-site energy network is available. In addition to the line-powered power tools, cordless power tools are also being used increasingly on construction sites, for which the energy supply is ensured by means of batteries or rechargeable batteries (“power packs”). In the context of the invention, such power tools are preferably referred to as “battery-powered power tools”.

According to a more recent development in the power-tool sector, power tools are meant to be able to communicate with other devices on a construction site. A communication capability of this type, which is preferably referred to as “connectivity” in the context of the invention, can be provided particularly easily in battery-powered power tools by the power packs or batteries having a “smart” design, for instance. In the context of the invention, the term “smart” is understood to mean that smart power packs and/or batteries are capable of facilitating connectivity of the power tool to which they are connected to another device.

Since line-powered power tools do not have any power packs or batteries, the option of the “smart” form of batteries or power packs clearly does not exist for these. The object of the present invention is thus to provide an electrical device that is capable of communicating with other devices, in particular in its surrounding area. The object is also to specify a technical solution for facilitating the connectivity, which can be implemented in a particularly simple and straightforward manner, for example in the power-tool sector. A further object of the invention consists in specifying a communication system in which two or more electrical devices can communicate with one another, wherein at least one of the electrical devices is meant to be a line-powered electrical device.

According to the invention, a power cable is provided for an electrical device, which power cable has a plug and a functional unit. The plug comprises a first group of contacts for supplying energy to the electrical device, and a second group of contacts for data transfer between the power cable and the electrical device. The functional unit has a first interface for data exchange between the electrical device and the functional unit.

The power cable can be connected to the electrical device by means of the plug. This can be done in particular via a plug-in connection. In particular, the electrical device may be a power tool, preferably a line-powered power tool. Power tools may be, for example, screwdrivers, cut-off or cutting devices, grinders, saws, chisels, core drills and simple drills and/or setting tools, without being restricted thereto. In the context of the present invention, these electrical devices may be equipped with a power cable, and can be connected by means of the power cable to a public or construction-site energy network in order to ensure a supply of energy or electricity. In other words, the electrical device can use the proposed power cable to draw from an electricity network the energy it needs for operation. The plug of the power cable is used in particular here to connect the power cable to the electrical device. In particular, the electrical device may be a power tool that is not battery-powered but can be connected to a public and/or construction-site energy network by a power cable. For example, the power cable proposed in the context of this invention can be used for this connection.

The plug preferably comprises an electrical terminal arrangement, which is formed by two groups of contacts. The first group of contacts is designed to supply electrical energy to the electrical device, whereas the second group of contacts is designed to facilitate data transfer between the power cable and the electrical device. It is preferred according to the invention that the electrical terminal arrangement having the two groups of contacts forms a wired or wire-based interface, where the terms “wired” and “wire-based” are preferably used synonymously in the context of the invention.

The first group in the electrical terminal arrangement comprises a number of contacts from one to four, preferably two contacts. It is preferred according to the invention that the second group in the electrical terminal arrangement likewise comprises a number of contacts from one to four, preferably two contacts. Hence the electrical terminal arrangement can form in particular a four-wire interface, which four-wire interface is designed preferably both to supply energy to the electrical device and to facilitate communication between the power cable and the electrical device. The first group and the second group of contacts preferably form a wired interface inside the plug of the power cable, wherein the electrical device can be connected to the power cable by means of the plug.

In a preferred configuration of the invention, the plug of the proposed power cable comprises a wired interface, which wired interface is preferably in the form of a four-wire interface. A socket for the plug preferably comprises in particular two energy-supply contacts and two communication contacts. It is preferred according to the invention that the two energy-supply contacts form the first group of contacts of the plug, whereas the two communication contacts form the second group of contacts of the plug. The energy-supply contacts and the communication contacts together preferably form the electrical terminal arrangement of the plug of the proposed power cable. Thus the first group and the second group of contacts form a wired interface inside the plug of the power cable.

In the context of the invention, the contacts can also be referred to as pins, with the terms “pin” and “contact” preferably being used synonymously in the context of the invention. It is preferred according to the invention that the plug comprises a first group of first pins for supplying energy to the electrical device, and a second group of second pins for data transfer between the power cable and the electrical device. The first pins preferably constitute energy-supply contacts of the plug, whereas the second pins form communication contacts of the plug. The pins, or the energy-supply contacts and the communication contacts, preferably form the electrical terminal arrangement of the plug or of the proposed power plug, wherein the power cable can be connected via the electrical terminal arrangement or via the plug to the electrical device that is meant to be supplied with electricity.

In addition to the plug, the power cable comprises a functional unit, which has a first interface for data exchange between the electrical device and the functional unit. This first interface of the functional unit of the proposed power cable is preferably in the form of a wired interface. It is preferred according to the invention that there is an electrical connection between the plug of the proposed power cable and the functional unit, which electrical connection is formed by cables or a shard printed circuit board. According to the invention, it is preferred in particular that this electrical connection is formed between a wired interface of the plug and the functional unit, which wired interface preferably comprises the contacts of the first group and of the second group and forms the electrical terminal arrangement of the plug.

It is preferred according to the invention that the functional unit is located on, or in, the power cable. In other words, the functional unit may be inbuilt in the power cable. It is also possible that the functional unit is located outside the power cable. The functional unit preferably has a first interface and a second interface, which first interface of the functional unit is preferably designed to facilitate data exchange between the electrical device and the power cable, in particular its functional unit. The first interface of the functional unit thus forms a communication module of the power cable or of the functional unit, and can preferably also be referred to as a “communication module”.

In a particularly preferred configuration of the invention, the functional unit of the power cable has a second interface, which second interface is designed to facilitate wireless communication with a further electrical device. It is thus preferred according to the invention that the second interface is in the form of a wireless interface. In this embodiment of the invention, connectivity between the electrical device and a further electrical device can be facilitated by means of the power cable. In other words, the proposed power cable can be used to turn the first electrical device into a “smart”, i.e., connective, device without having to carry out structural modifications to the electrical device to achieve this. It is an essential advantage of the invention that the proposed power cable can be used to facilitate communication or data exchange between two electrical devices, where at least one of the devices is a line-powered electrical device that can be supplied with electrical energy via the power cable. Although the communication or data exchange between the electrical devices takes place preferably wirelessly, data is transferred between the functional unit and the first electrical device by wired means inside the power cable. The communication between the electrical devices hence preferably constitutes a combination of wireless and wired communication. The wireless portion of the communication is associated with the advantage of no cabling being needed between the electrical devices that are communicating with one another. This is advantageous because cables can pose a safety risk, in particular on construction sites or in public spaces. Thus avoiding additional cables can help to make a construction site safer.

A further advantage of the invention is that there is no need to carry out complex structural modifications to the first electrical device in order to facilitate connectivity. In particular, there is no need to provide costly electrical or galvanic isolation, which potentially also makes additional and complex approval testing necessary. Hence the invention can facilitate particularly cost-effective communication between electrical devices. By virtue of the invention, advantageously there is also no need for any additional touch-protection.

Furthermore, the power cable can be exchanged in a particularly simple and straightforward manner if another or a new communication technique is meant to be used for communication between the electrical devices involved. For example, if the communication between the first electrical device and the further electrical device was based initially on 2G and in future is meant to be converted to Bluetooth, then another power cable can simply be used for supplying energy to the electrical device, with this other or new power cable being designed to facilitate Bluetooth communication. A communication system that is particularly flexible and simple to adapt can be provided in this way. It is preferred according to the invention that the further electrical device, which is preferably the communication partner of the first electrical device, has corresponding communication means. The second or further electrical device is thereby designed to receive the preferably wireless communication signal from the power cable or its functional unit or its communication module, or to transmit communication signals to the first electrical device. The communication signals that are exchanged may be, for example, machine-related data such as operating parameters or identification codes, control commands and/or indication signals, without being restricted thereto.

It is preferred according to the invention that the functional unit of the proposed power cable has a first interface for data exchange between the electrical device and the functional unit, and a second interface for wireless communication with a further electrical device. The first interface for data exchange between the electrical device and the functional unit is in wired form, whereas the second interface for wireless communication between the first and the second or further electrical device is in wireless form. The wired first interface of the functional unit of the power cable preferably facilitates a preferably bidirectional data exchange between the electrical device and the functional unit, where the communication can be based preferably on UART, I2C, SPI. The wireless second interface of the functional unit of the power cable preferably facilitates a preferably bidirectional data exchange between at least two electrical devices, where at least one of the electrical devices is a line-powered electrical device such as a line-powered power tool. The communication by the second interface of the functional unit may be based on NB-IoT, 2G, CAT-M1, LORA, Bluetooth and/or Zigbee, for example, without being restricted thereto.

It is very particularly preferred according to the invention that the first electrical device is a line-powered power tool. The further electrical device may be a mobile communication device such as a cell phone, a smartphone, a Notebook, a laptop, a Palm PC, a tablet PC or the like, without being restricted thereto. The further or second electrical device may also be a remote control, a stationary computer (PC), a cloud, a server or the like, without being restricted thereto. In addition, the further or second electrical device may also be an auxiliary device, with which the first electrical device works or forms a work system. Such an auxiliary device may be, for example, a vacuum cleaner, a water-management or recycling system, a feed apparatus or an external control unit.

It is preferred according to the invention that the power cable has a transmit unit and a receive unit for wireless communication with the further electrical device. According to the invention, it is preferred in particular that the transmit unit and the receive unit are constituent parts of the functional unit, and can be used for wireless communication with a further electrical device. The transmit unit and the receive unit are preferably constituent parts of the second interface of the functional unit of the proposed power cable. In other words, the transmit unit and/or the receive unit is/are part of the functional unit or of the second interface. By providing the transmit unit and/or the receive unit, the functional unit or the power cable can be equipped to facilitate preferably wireless communication between the first electrical device and the further electrical device. The transmit unit and the receive unit preferably support the aforementioned communication techniques, in particular the wireless communication techniques mentioned such as NB-IoT, 2G, CAT-M1, LORA, Bluetooth and/or Zigbee.

It is preferred according to the invention that the second electrical device has corresponding communication means. According to the invention, this preferably means that the second electrical device has, for example, also transmit units and receive units that can communicate with the transmit unit and the receive unit of the functional unit of the power cable. In particular, it is preferred that the functional unit and the second electrical device, by means of their transmit units and receive units, are capable of exchanging, and sending back and forth in the sense of a bidirectional connection, communication signals, data or commands.

In a second aspect, the invention relates to an electrical device which can be connected to a proposed power cable, in particular in order to ensure a supply of energy to the electrical device. It is preferred according to the invention that the electrical device comprises a mechanical interface for receiving a plug of the power cable. It is preferred according to the invention that the connection between the electrical device and the power cable preferably facilitates both a supply of energy to the electrical device and a preferably wired or contact-based data exchange between electrical device and power cable.

The plug of the power cable can preferably be connected to electronics of the electrical device. Communication signals, which the functional unit of the power cable receives from the second electrical device, can thereby be routed directly to the electronics of the first electrical device, with the result that, for example, control commands can be transferred to the electrical device and implemented particularly quickly and efficiently. The electronics of the first electrical device can comprise, for example, a control apparatus, which can preferably be designed to implement communication signals or control commands that are received from the second electrical device and transferred by the power cable or its communication module to the first electrical device. It is preferred according to the invention that an electrical connection exists between the mechanical interface and the electronics of the electrical device. The power cable can preferably be designed to supply the electrical device with energy, in particular electricity, and to facilitate a preferably bidirectional exchange of data, for instance machine-related data, between the functional unit of the power cable and the first electrical device, and between the first electrical device and the second electrical device.

In a further aspect, the invention relates to a system which comprises a proposed power cable, a proposed electrical device and a further electrical device. Communication between the power cable and the electrical device is performed by means of a first interface of the functional unit of the power cable, and communication between the power cable and the further electrical device is performed by means of a second interface of the functional unit of the power cable. In the context of the invention, the proposed system can preferably also be referred to as a communication system. The definitions, technical effects and advantages introduced and described for the power cable and the electrical device apply analogously to the communication system, and vice versa.

It is preferred according to the invention that the communication or data transfer between the power cable and the electrical device is performed by wired means, i.e., by means of wires, whereas the communication or data transfer between the power cable and the further electrical device or between the at least two electrical devices is performed wirelessly.

The invention advantageously facilitates communication or data transfer between preferably line-powered electrical devices using a “smart”, i.e., connective, power cable. The power cable preferably has a plug and a functional unit, which plug and functional unit constitute additional communication interfaces in the power cable which facilitate data transfer. The interfaces are preferably inbuilt interfaces, wherein an electrical terminal arrangement of the plug facilitates wired communication between power cable and electrical device, and the functional unit facilitates wireless communication between at least two electrical devices. One of the devices may be, for example, a line-powered power tool, whereas the second electrical device may be a cloud, a smartphone, an auxiliary device, a remote control or a PC.

The proposed power cable preferably facilitates the supply of energy or electricity to the electrical device, which power cable preferably comprises communication contacts in the plug that is also used for feeding through the electrical energy. The plug preferably comprises both energy-supply and communication contacts, which preferably form an electrical terminal arrangement. This electrical terminal arrangement may have a connection to a functional unit of the power cable, which electrical connection can be realized by means of thin cables or a shared printed circuit board. These cables and/or the shared printed circuit board preferably form an electrical connection between the plug and the functional unit. The functional unit may be located on, or in, the power cable.

The functional unit can preferably comprise two interfaces, wherein a first interface is in wired form and can have a connection to electronics of the electrical device. The second interface preferably is in wireless form, and facilitates the data exchange with an external electrical device.

An essential advantage of the invention is that the proposed power cable can facilitate data exchange, for instance between electrical devices, without the first electrical device, for instance a line-powered power tool, needing to have a communication module. Instead, communication signals and data intended for the power tool are transmitted preferably wirelessly to the functional unit of the power cable, and from here routed preferably by wired means to the power tool or the electronics thereof. For example, the electrical terminal arrangement having the communication contacts can be used for this purpose.

Of course the communication or data exchange works correspondingly if the electrical device or the line-powered power tool is the transmitting device, and the second electrical device is the receiving device within the communication system.

In particular, the invention allows the readout of operating parameters or device parameters of the first electrical device, for instance a running time, a position or an error message. Furthermore, such operating parameters or device parameters can be set or adjusted by means of the invention. In other words, the invention can be used to transfer data, control commands or parameters from an external device such as a further electrical device to the first electrical device via the power cable. According to the invention, this preferably means that the first electrical device, for example the line-powered power tool, can be controlled externally by means of the proposed power cable, for example by the transmission of control commands or the setting of operating parameters. These communication signals, control commands or operating parameters preferably originate from the further or second electrical device, which may have a communicative connection to the first electrical device via the functional unit of the power cable and the communication contacts. The communication between the electrical devices preferably constitutes a combination of wireless data transfer between second electrical device and functional unit of the power cable, and wired data transfer between the plug of the power cable and the first electrical device.

Further advantages will become apparent from the following description of the FIGURE. The FIGURE, the description and the claims contain numerous features in combination. A person skilled in the art will expediently also consider the features individually and combine them to form useful further combinations. Identical and similar components are denoted by the same reference signs in the FIGURE.

### BRIEF DESCRIPTION OF THE DRAWING

The FIGURE shows a view of a preferred configuration of the communication system.

### DETAILED DESCRIPTION OF THE DRAWING

The FIGURE shows a preferred embodiment of a proposed communication system 50. The communication system 50 shown in the FIGURE comprises a first electrical device 10, a power cable 1 and a further electrical device 20. The first electrical device 10 may be a line-powered power tool for instance. The supply of energy to the first electrical device 10 is ensured via the power cable 1, which power cable 1 additionally has, or performs, a communication function. In order to perform the communication function, the power cable 1 has a plug 2 and a functional unit 3. The plug 2 has a first group 4 of supply contacts 4a, and has a second group 5 of communication contacts 5a. The contacts 4a, 5a together form an electrical terminal arrangement, or wired or wire-based interface, inside the plug 2 of the power cable 1. The plug 2 of the power cable 1 can be connected to the electrical device 10, which electrical device 10 has a mechanical interface 12 for connecting to the plug 2. The mechanical interface 12 of the electrical device 10 may be in the form of a receptacle for the plug 2, for instance. Between the mechanical interface 12 and the electronics 13 of the electrical device 10 preferably exists an electrical connection 14, which is indicated in the FIGURE by a connecting line between the components 12 and 13.

The power cable 1 has a functional unit 3, which forms the communication module of the power cable 1. The functional unit 3 is connected via an electrical connection 8 to the plug 2. The functional unit 3 has a first interface 6 and a second interface 7, where the first interface 6 is a wired interface, and the second interface 7 of the functional unit 3 is a wireless interface. The second interface 7 may have a transmit unit 9 and a receive unit 11, and the second interface 7 is designed in particular for wireless communication with a further electrical device 20. In particular it is the transmit unit 9 and the receive unit 11 of the second interface 7 of the functional unit 3 that facilitate the wireless communication by the power cable 1. The second interface 7 preferably ensures the preferably wireless communication between power cable 1 and second electrical device 20, whereas the first interface 6 and the second group 5 of contacts 5a ensure the wired communication between the power cable 1 and the first electrical device 10 on the one side, and the second electrical device 20 on the other. The first interface 6 of the functional unit 3 is designed for wired communication with the first electrical device 10, the communication being performed in particular via the electrical connection 8 between plug 2 and functional unit 3, and via the communication contacts 5a of the plug 2 of the power cable 1.

The invention facilitates in particular communication between the first electrical device 10 and the second or further electrical device 20, the communication having a wired portion between electrical device 10 and power cable 1, and a wireless portion between functional unit 3 of the power cable 1 and the further electrical device 20.

The first group 4 of contacts 4a ensures the supply of energy or electricity to the first electrical device 10. The contacts 4a of the first group 4 can therefore preferably be referred to as “supply contacts”. The contacts 5a of the second group 5 ensure the preferably wired communication between the power cable 1 and the first electrical device 10. The contacts 5a of the second group 5 can therefore preferably be referred to as “communication contacts”.

### LIST OF REFERENCE CHARACTERS

1 power cable
2 plug
3 functional unit
4 first group of contacts (4a)
5 second group of contacts (5a)
6 first interface of the functional unit
7 second interface of the functional unit
8 electrical connection between plug and functional unit
9 transmit unit
10 (first) electrical device
11 receive unit
12 mechanical interface
13 electronics of the first electrical device
14 electrical connection between the mechanical interface and the electronics of the electrical device
20 further electrical device
50 communication system

1.-15. (canceled)

16. A power cable (1) for an electrical device (10), comprising:
a plug (2); and
a functional unit (3);
wherein the plug (2) comprises:
a first group (4) of contacts (4a) for supplying energy to the electrical device (10); and
a second group (5) of contacts (5a) for data transfer between the power cable (1) and the electrical device (10);
wherein the functional unit (3) has a first interface (6) for data exchange between the electrical device (10) and the functional unit (3).

17. The power cable (1) as claimed in claim 16, wherein the first interface (6) of the functional unit (3) is a wired interface.

18. The power cable (1) as claimed in claim 16, wherein the first group (4) comprises a number of contacts (4a) from one to four.

19. The power cable (1) as claimed in claim 16, wherein the second group (5) comprises a number of contacts (5a) from one to four.

20. The power cable (1) as claimed in claim 16, wherein an electrical connection (8) is disposed between the plug (2) and the functional unit (3) and wherein the electrical connection (8) is a cable or a printed circuit board.

21. The power cable (1) as claimed in claim 16, wherein the functional unit (3) is disposed on, or in, the power cable (1).

22. The power cable (1) as claimed in claim 16, wherein the functional unit (3) has a second interface (7) for wireless communication with a further electrical device (20).

23. The power cable (1) as claimed in claim 16, wherein the functional unit (3) has a transmit unit (9) and a receive unit (11) for wireless communication with a further electrical device (20).

24. An electrical device (10) which is connectable to the power cable (1) as claimed in claim 16, comprising:
a mechanical interface (12) for receiving the plug (2) of the power cable (1).

25. The electrical device (10) as claimed in claim 24, wherein the electrical device (10) is a power tool.

26. The electrical device (10) as claimed in claim 24, wherein the electrical device (10) has electronics (13) which are connectable to the plug (2) of the power cable (1).

27. The electrical device (10) as claimed in claim 26, wherein an electrical connection (14) is disposed between the mechanical interface (12) and the electronics (13) of the electrical device (10).

28. A system (50), comprising:
a power cable (1) for an electrical device (10), wherein the power cable (1) comprises:
a plug (2); and
a functional unit (3);
wherein the plug (2) comprises:
a first group (4) of contacts (4a) for supplying energy to the electrical device (10); and
a second group (5) of contacts (5a) for data transfer between the power cable (1) and the electrical device (10;
wherein the functional unit (3) has a first interface (6) for data exchange between the electrical device (10) and the functional unit (3);
a first electrical device (10) which is connectable to the power cable (1), wherein the first electrical device (10) comprises:
a mechanical interface (12) for receiving the plug (2) of the power cable (1);
a second electrical device (20);
wherein communication between the power cable (1) and the first electrical device (10) is performed by the first interface (6) of the functional unit (3) of the power cable (1) and wherein communication between the power cable (1) and the second electrical device (20) is performed by a second interface (7) of the functional unit (3) of the power cable (1).

29. The system (50) as claimed in claim 28, wherein the communication between the power cable (1) and the first electrical device (10) is performed by a wired connection.

30. The system (50) as claimed in claim 28, wherein the communication between the power cable (1) and the second electrical device (20) is performed wirelessly.
